(19) United States
(12) Patent Application Publication
(10) Pub. No.: US 2026/0366467 A1
(43) Pub. Date: Nov. 19, 2026

(54) Control Device for Fuel Injection Device

(71) Applicant: Astemo, Ltd., Chiyoda-ku, Tokyo (JP)

(72) Inventors: Ryo KUSAKABE, Hitachinaka-shi, Ibaraki (JP); Kunihiko SUZUKI, Hitachinaka-shi, Ibaraki (JP)

(73) Assignee: ., (omitted)

(21) Appl. No.: 19/157,083

(22) PCT Filed: Jun. 27, 2023
(86) PCT No.: PCT/JP2023/023787

§ 371 Date: Aug. 15, 2025

(51) Int. Cl. F02D 41/40; F02D 41/02; F02D 41/38; F02P 5/04

(52) U.S. Cl. CPC F02D 41/402; F02D 41/0255; F02P 5/045; F02D 2041/389

(57) ABSTRACT

An object of the present invention is to achieve both ensuring of combustion stability of an internal combustion engine and reduction of a particulate number (PN) during an operation in a catalyst warm-up mode with ignition retardation. A control device 150 is a control device for a fuel injection device 101 that directly injects a fuel into an in-cylinder space 615 of an internal combustion engine 10 operating in a catalyst warm-up mode in which a catalyst is warmed up by the ignition retardation in which an ignition timing is retarded to an expansion stroke. The control device 150 controls the fuel injection device 101 such that fuel injection immediately before the ignition timing among a plurality of fuel injections performed during one combustion cycle is performed in the expansion stroke during the operation in the catalyst warm-up mode, and an injection amount of the fuel injection immediately before the ignition timing decreases as the ignition timing is retarded.

### TECHNICAL FIELD

The present invention relates to a control device that controls a fuel injection device of an internal combustion engine.

### BACKGROUND ART

In recent years, with the tightening of exhaust regulations, it is required to reduce the total amount of particulate matter (PM) discharged in a traveling mode defined in a fuel consumption standard such as worldwide harmonized light vehicles test cycle (WLTC), a particulate number (PN) which is the number thereof, hydrocarbon (HC), and nitrogen oxide (NOX) in an internal combustion engine. The PN and HC are generated when a fuel injected from a fuel injection device adheres to a piston and a wall surface in an in-cylinder space. In order to reduce the PN and HC, it is effective to reduce fuel adhesion. The PN tends to increase when there is a region where an equivalence ratio, which is a ratio of air to fuel, is large immediately before ignition, that is, a fuel-rich air-fuel mixture exists in the in-cylinder space. A large amount of HC is discharged at the time of starting the internal combustion engine in which a catalyst is not activated. As a technology for early activation of the catalyst, there is known an ignition retardation technology in which an ignition timing is retarded beyond an idling timing after completion of catalyst warm-up to increase an exhaust loss and increase an exhaust temperature, thereby increasing a temperature of the catalyst early. An operation mode of the internal combustion engine in which the catalyst is warmed up by the ignition retardation is also referred to as a “catalyst warm-up mode”.

The ignition retardation refers to retardation of the ignition timing from the optimum ignition timing for the best fuel efficiency. Specifically, in the ignition retardation, the ignition timing is retarded to an expansion stroke which is a stroke from a top dead center to a bottom dead center after a compression stroke ends. However, the ignition retardation tends to cause unstable combustion. In order to reliably perform ignition and enhance combustion stability, it is necessary to form a rich air-fuel mixture necessary for ignition around a spark plug.

As a technology for forming the rich air-fuel mixture around the spark plug at the ignition timing, a technology in which a cavity is formed on a crown surface of the piston and the fuel is injected in the compression stroke to swirl the air-fuel mixture put in the cavity to concentrate the air-fuel mixture around the spark plug is effective. In addition, as a technology for forming the rich air-fuel mixture around the spark plug at the ignition timing, a technology in which the fuel injection device is disposed in the vicinity of the spark plug (hereinafter, also referred to as a “center injection type”) and the fuel is injected immediately before the ignition timing is effective.

PTL 1 discloses a technology in which a period from an end timing of fuel injection in the expansion stroke to the ignition timing is shortened as the ignition timing of the expansion stroke is retarded in order to ensure the combustion stability.

### CITATION LIST

### Patent Literature

PTL 1: WO 2016/194184 A

### SUMMARY OF INVENTION

### Technical Problem

Penetration (reaching distance) of a spray of the fuel injected from the fuel injection device is likely to change depending on a change in pressure in the in-cylinder space. As the ignition timing of the expansion stroke is retarded, the pressure in the in-cylinder space decreases, as a result of which the penetration of the spray tends to increase. When the penetration of the spray increases, the spray is easily diffused into the in-cylinder space, and it becomes difficult to maintain the air-fuel mixture around the spark plug at the ignition timing. In particular, in the case of the center injection type in which the fuel injection device is disposed in the vicinity of the spark plug, the spark plug and a fuel injection position are close to each other, and thus, it is necessary to perform the fuel injection immediately before the ignition timing in order to maintain the air-fuel mixture around the spark plug at the ignition timing.

When the period from the end timing of the fuel injection in the expansion stroke to the ignition timing is shortened as the ignition timing of the expansion stroke is retarded, the end timing of the fuel injection approaches the ignition timing. In this case, a time during which the spray can be vaporized is shortened, and thus, the fuel easily adheres to the piston and the wall surface in the in-cylinder space at the ignition timing, and the PN may increase. The technology disclosed in PTL 1 does not consider such a problem at all, and there is room for improvement.

The present invention has been made in view of the above, and an object of the present invention is to achieve both ensuring of combustion stability of an internal combustion engine and reduction of a PN during an operation in a catalyst warm-up mode with ignition retardation.

### Solution to Problem

In order to solve the above problem, a control device for a fuel injection device according to the present invention is a control device for a fuel injection device that directly injects a fuel into an in-cylinder space of an internal combustion engine operating in a catalyst warm-up mode in which a catalyst is warmed up by ignition retardation in which an ignition timing is retarded to an expansion stroke, the control device controlling the fuel injection device such that fuel injection immediately before the ignition timing among a plurality of fuel injections performed during one combustion cycle is performed in the expansion stroke during the operation in the catalyst warm-up mode, and an injection amount of the fuel injection immediately before the ignition timing decreases as the ignition timing is retarded.

### Advantageous Effects of Invention

According to the present invention, it is possible to achieve both ensuring of combustion stability of the internal combustion engine and reduction of a PN during the operation in the catalyst warm-up mode with the ignition retardation.

Problems, configurations, and effects other than the above will be clarified by the following description of embodiments.

### BRIEF DESCRIPTION OF DRAWINGS

FIG. 1 is a view illustrating a schematic configuration of an internal combustion engine including a fuel injection device.

FIG. 2 is a view illustrating a schematic configuration of an internal combustion engine system including the internal combustion engine illustrated in FIG. 1.

FIG. 3 is a diagram illustrating a longitudinal cross-sectional view of the fuel injection device illustrated in FIG. 1 and a schematic configuration of a control device.

FIG. 4 is an enlarged view of the vicinity of a movable element and a valve body of FIG. 3.

FIG. 5 is a diagram illustrating a relationship among an injection pulse output from an engine control unit (ECU), a drive voltage applied to a solenoid of the fuel injection device, a drive current supplied to the solenoid, and displacement amounts of the valve body and the movable element.

FIG. 6 is a diagram for describing fuel injection control performed during an operation in a catalyst warm-up mode.

FIG. 7 is a projection view of a spray injected from the fuel injection device.

FIG. 8 is a diagram illustrating a relationship between penetration of the spray injected from the fuel injection device and a pressure of an in-cylinder space.

FIG. 9 is a diagram for describing a first embodiment in the fuel injection control immediately before an ignition timing, the fuel injection control being performed during the operation in the catalyst warm-up mode.

FIG. 10 is a diagram for describing a second embodiment in fuel injection control immediately before an ignition timing, the fuel injection control being performed during an operation in a catalyst warm-up mode.

FIG. 11 is a diagram illustrating a relationship among an injection pulse output from an ECU, a drive voltage applied to a solenoid of a fuel injection device, a drive current supplied to the solenoid, and a displacement amount of a valve body in the second embodiment.

FIG. 12 is a diagram illustrating a relationship between an injection pulse width and an injection amount of the fuel injection device.

FIG. 13 is a diagram illustrating a relationship among an ignition retardation amount, a fuel pressure, an injection amount, a rotation speed of an internal combustion engine, and an elapsed time from the start of the internal combustion engine.

FIG. 14 is a diagram for describing a third embodiment in fuel injection control immediately before an ignition timing, the fuel injection control being performed during an operation in a catalyst warm-up mode.

### DESCRIPTION OF EMBODIMENTS

Hereinafter, embodiments of the present invention will be described with reference to the drawings. Note that configurations or functions denoted by the same reference numerals in the respective embodiments have similar configurations or functions in the respective embodiments, and a description thereof will be omitted unless otherwise specified.

### First Embodiment

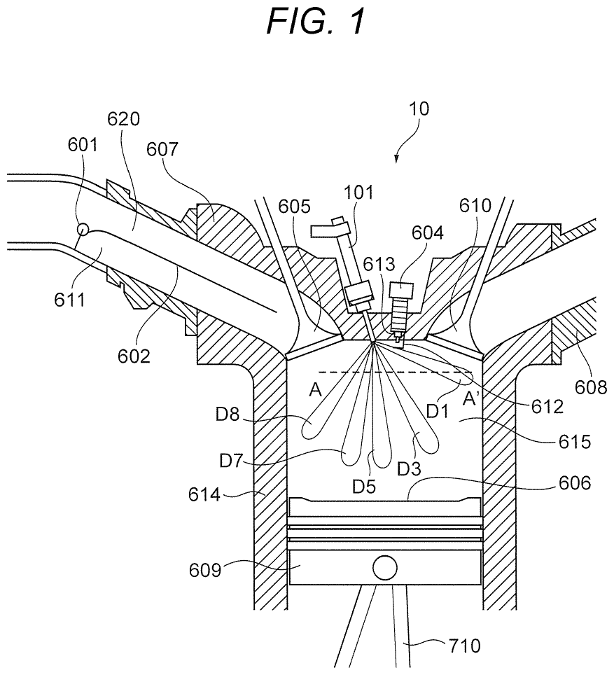

A control device 150 for a fuel injection device 101 according to a first embodiment will be described with reference to FIGS. 1 to 9. FIG. 1 is a view illustrating a schematic configuration of an internal combustion engine 10 including the fuel injection device 101.

The internal combustion engine 10 is a direct injection type internal combustion engine that directly injects a fuel into an in-cylinder space 615. The internal combustion engine 10 includes the fuel injection device 101, a spark plug 604, an intake port 607, an exhaust port 608, a cylinder 614, a piston 609, an intake valve 605, and an exhaust valve 610.

The spark plug 604 is disposed at the center of an upper portion of the cylinder 614. In the spark plug 604, a negative electrode 612 and a positive electrode 613 are exposed to the in-cylinder space 615. The fuel injection device 101 is a center injection type fuel injection device that is disposed in the vicinity of the spark plug 604 and injects the fuel into the in-cylinder space 615. The fuel injection device 101 may be a port injection type fuel injection device that is disposed on the intake port 607 and injects the fuel into the intake port 607.

A crown surface 606 of the piston 609 on a side that is adjacent to the spark plug 604 is a flat surface. A partition wall 602 is attached to the intake port 607 to block a flow between an upper portion 620 and a lower portion 611 of the intake port 607. A valve 601 is provided upstream of the partition wall 602, and the valve 601 is configured to be controlled to be opened and closed by the control device 150. FIG. 1 illustrates a state in which the valve 601 is closed.

In FIG. 1, the intake valve 605 and the exhaust valve 610 are illustrated for convenience of description. However, in the general direct injection type internal combustion engine 10 to which two intake valves 605 and two exhaust valves 610 are attached, the intake valves 605 and the exhaust valves 610 are not illustrated in a cross-sectional view passing through a central axis of the cylinder 614. FIG. 1 also illustrates spray states (D1 to D8) in the in-cylinder space 615 immediately after the fuel is injected from the fuel injection device 101.

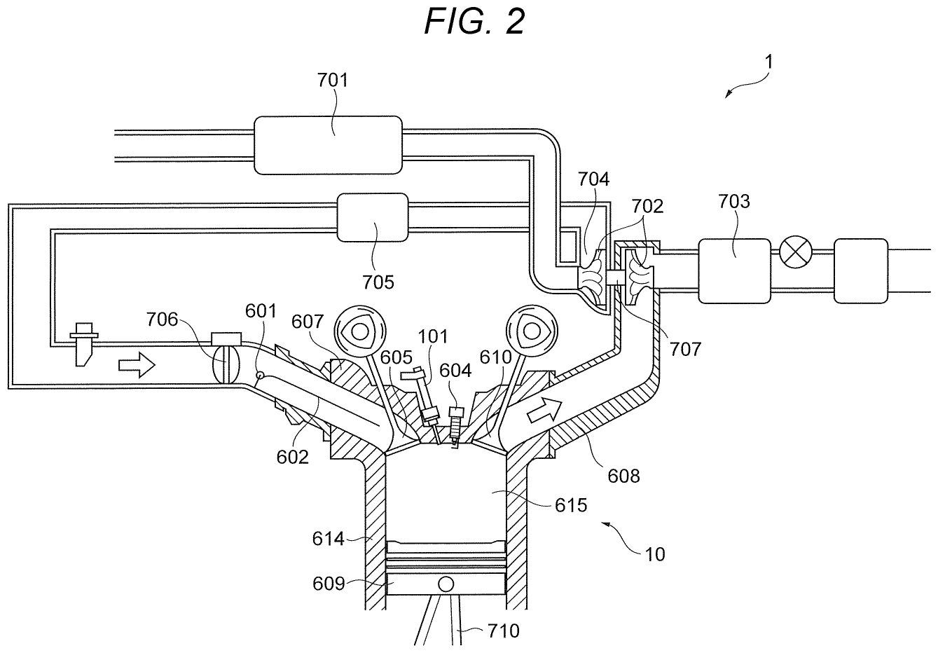

FIG. 2 is a view illustrating a schematic configuration of an internal combustion engine system 1 including the internal combustion engine 10 illustrated in FIG. 1.

An air that flows into the in-cylinder space 615 of the internal combustion engine 10 flows in after passing through an air cleaner 701, a supercharging chamber 704 provided with turbines 702 of a supercharger, an intercooler 705, a throttle valve 706, and the intake port 607. The air cleaner 701 has a function of removing dust in the air and preventing the dust from being sucked into the in-cylinder space 615, thereby suppressing wear of the cylinder 614 and the piston 609.

In the supercharging chamber 704, the turbines 702 are provided on an intake side and an exhaust side and are connected by a shaft 707. Therefore, the turbines 702 rotate according to a flow velocity of exhaust gas, and an amount of the air flowing into the in-cylinder space 615 is increased to improve an output. A temperature of the air that has passed through the supercharging chamber 704 increases due to supercharging by the turbine 702, and thus, the air is cooled by the intercooler 705. The cooled air passes through the throttle valve 706 that adjusts the amount of the air and the intake port 607, and flows into the in-cylinder space 615.

The air flowing into the in-cylinder space 615 is mixed with the fuel injected from the fuel injection device 101 to form an air-fuel mixture, and is ignited and combusted by the spark plug 604. After the piston 609 is pushed down by the combustion and a driving force of the piston 609 is transmitted to a crankshaft 710, the exhaust valve 610 is opened. The exhaust gas in the in-cylinder space 615 passes through the exhaust port 608, causes the turbine 702 to rotate according to a flow velocity of the exhaust gas, and passes through a catalyst device 703.

As the exhaust gas passes through the catalyst device 703, hydrocarbon (HC), nitrogen oxide (NOX), and carbon monoxide (CO) are reduced, and the exhaust gas is discharged to the outside of a vehicle. The catalyst device 703 includes, for example, a three-way catalyst. The catalyst device 703 removes HC, NOx, and CO contained in the exhaust gas by causing reduction and oxidation reactions to occur with the catalyst using palladium, rhodium, platinum, and the like. However, the catalyst device 703 has a low reduction capability when a temperature of the catalyst is low. In particular, under low-temperature conditions such as during starting of the internal combustion engine 10, combustion for warming up the catalyst early is required.

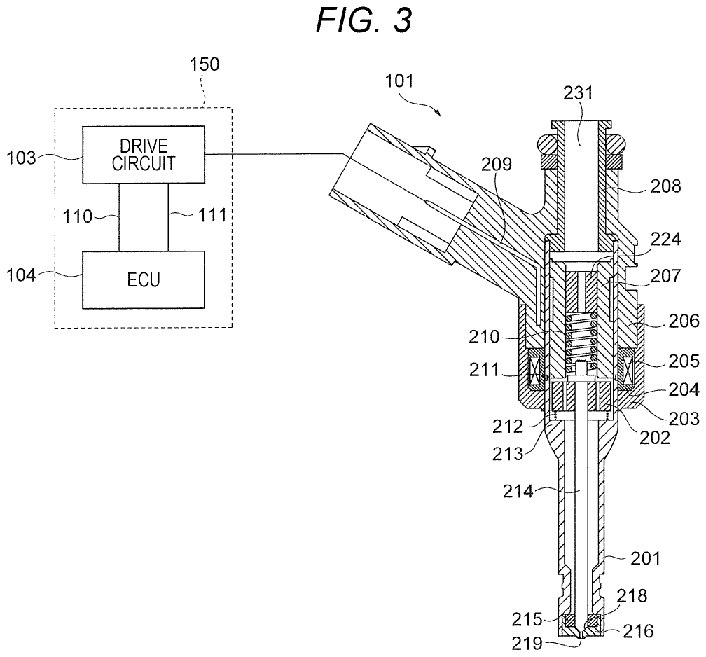

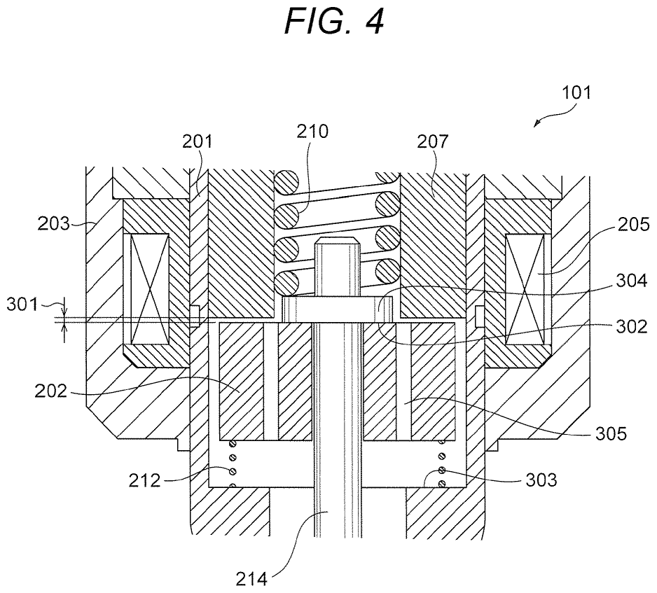

FIG. 3 is a diagram illustrating a longitudinal cross-sectional view of the fuel injection device 101 illustrated in FIG. 1 and a schematic configuration of the control device 150. FIG. 4 is an enlarged view of the vicinity of a movable element 202 and a valve body 214 of FIG. 3.

The fuel injection performed by the fuel injection device 101 is controlled by an injection pulse output from an engine control unit (ECU) 104. The ECU 104 includes an A/D converter and an I/O port for receiving signals from various sensors. The ECU 104 receives signals indicating a state of the internal combustion engine 10 from various sensors, and computes a pulse width of the injection pulse (injection pulse width) for controlling an injection amount of the fuel injection and a start timing and an end timing of the fuel injection according to an operation condition or an operation mode of the internal combustion engine 10. The injection pulse output from the ECU 104 is input to a drive circuit 103 through a signal line 110. The drive circuit 103 determines a drive current waveform to be supplied to a solenoid 205 of the fuel injection device 101 based on a command from the ECU 104, and supplies the drive current waveform to the solenoid 205 of the fuel injection device 101 during a time based on the injection pulse.

The ECU 104 communicates with the drive circuit 103 through a communication line 111. The ECU 104 can switch the drive current waveform determined by the drive circuit 103 and change set values of a current and a time according to a pressure of the fuel supplied to the fuel injection device 101, and the operation condition or the operation mode of the internal combustion engine 10. The drive circuit 103 may be mounted as a component or a substrate integrated with the ECU 104. In the present embodiment, the drive circuit 103 and the ECU 104 are also collectively referred to as the “control device 150”.

The fuel injection device 101 is a normally-closed electromagnetic valve (electromagnetic fuel injection device). As illustrated in FIG. 3, the fuel injection device 101 includes the valve body 214 that closes or opens a fuel injection hole 219 through which the fuel is injected. In a state in which the solenoid 205 is not energized, the valve body 214 is biased in a valve closing direction (a lower side in FIG. 3) by a spring 210 which is a first spring, and is in close contact with a valve seat 218 to be in a valve closed state. In the valve closed state, a force applied by a return spring 212 which is a second spring in a valve opening direction (an upper side in FIG. 3) acts on the movable element 202. At this time, since a force applied by a spring 210 and acting on the valve body 214 is larger than the force applied by the return spring 212, an end surface 302 of the movable element 202 comes into contact with the valve body 214, and the movable element 202 is stationary as illustrated in FIG. 4. The valve body 214 and the movable element 202 are configured to be relatively displaceable and are included in a nozzle holder 201. The nozzle holder 201 has an end surface 303 serving as a spring seat of the return spring 212. The force applied by the spring 210 is adjusted at the time of assembly according to a pushing amount of a spring retainer 224 fixed to an inner surface of a fixed element (core) 207.

In the fuel injection device 101, the fixed element 207, the movable element 202, the nozzle holder 201, and a housing 203 form a magnetic circuit. A gap 301 is provided between the movable element 202 and the fixed element 207. A magnetic constriction 211 is formed on a portion of the nozzle holder 201 that corresponds to the gap 301 between the movable element 202 and the fixed element 207. The solenoid 205 is attached on an outer peripheral side of the nozzle holder 201 while being wound around a bobbin 204. A rod guide 215 is provided in the vicinity of a tip portion of the valve body 214 on a side adjacent to the valve seat 218 so as to be fixed to the nozzle holder 201. The valve body 214 is guided to move in a valve axial direction (a vertical direction in FIG. 3) by two sliding portions of the fixed element 207 and the rod guide 215, the fixed element 207 being in contact with the spring seat 304 of the valve body 214. An orifice 216 in which the valve seat 218 and the fuel injection hole 219 are formed is fixed to a tip portion of the nozzle holder 201, and an internal space (fuel passage) provided between the movable element 202 and the valve body 214 is sealed from the outside.

The fuel supplied to the fuel injection device 101 is supplied from a rail pipe provided upstream of the fuel injection device 101, flows to a tip of the valve body 214 through a fuel passage hole 231, and is sealed between the valve seat 218 and the tip portion of the valve body 214 on the side adjacent to the valve seat 218. In the valve closed state, a differential pressure between an upper portion and a lower portion of the valve body 214 is generated by a fuel pressure, and the valve body 214 is pushed in the valve closing direction by a differential pressure force obtained by multiplying the fuel pressure and a pressure receiving area of an inner diameter at a position of the valve seat 218, and the force applied by the spring 210. When the drive current is supplied to the solenoid 205 in the valve closed state, a magnetic field is generated in the magnetic circuit, a magnetic flux passes between the fixed element 207 and the movable element 202, and a magnetic attraction force acts on the movable element 202. The movable element 202 starts to be displaced toward the fixed element 207 (upward in FIG. 3) at timing at which the magnetic attraction force acting on the movable element 202 exceeds the differential pressure force and the force applied by the spring 210.

After the valve body 214 starts a valve opening operation, the movable element 202 moves to a position of the fixed element 207 and collides with the fixed element 207. After the movable element 202 collides with the fixed element 207, the movable element 202 receives a reaction force from the fixed element 207 and bounces, but the movable element 202 is attracted to the fixed element 207 by the magnetic attraction force acting on the movable element 202 and eventually stops. At this time, since the return spring 212 applies the force to the movable element 202 toward the fixed element 207, a time required for the bounce to converge can be shortened. Since the bounce is small, a time during which the gap 301 between the movable element 202 and the fixed element 207 becomes large is shortened, and a stable operation can be performed even in a case where the injection pulse width is small.

The movable element 202 and the valve body 214 that have finished the valve opening operation in this manner become stationary in a valve opened state. In the valve opened state, a gap is generated between the valve body 214 and the valve seat 218, and the fuel is injected from the fuel injection hole 219. The fuel passes through a center hole provided in the fixed element 207 and a fuel passage hole 305 provided in the movable element 202 and flows in a downstream direction.

When the solenoid 205 is de-energized, the magnetic flux generated in the magnetic circuit disappears, and the magnetic attraction force also disappears. When the magnetic attraction force acting on the movable element 202 disappears, the movable element 202 and the valve body 214 are pushed back toward a valve closing position where the valve body 214 comes into contact with the valve seat 218 by the force applied by the spring 210 and the differential pressure force.

When closing the valve body 214 in the valve opened state, after the valve body 214 comes into contact with the valve seat 218, the movable element 202 moves in the valve closing direction away from the valve body 214 and the fixed element 207, moves for a certain time, and then is returned to an initial position in the valve closed state by the return spring 212.

At the moment when the valve body 214 collides with the valve seat 218 to complete the valve closing, the movable element 202 is separated from the valve body 214. As a result, the fuel injection device 101 can reduce a mass of a movable member at the moment when the valve body 214 collides with the valve seat 218 by a mass of the movable element 202. Therefore, the fuel injection device 101 can reduce collision energy when colliding with the valve seat 218 and can thus suppress bounce of the valve body 214 caused by the collision of the valve body 214 with the valve seat 218.

In the fuel injection device 101, relative displacement occurs between the valve body 214 and the movable element 202 at the moment of collision between the movable element 202 and the fixed element 207 at the time of valve opening and at the moment of collision between the valve body 214 and the valve seat 218 at the time of valve closing. As a result, the fuel injection device 101 can suppress the bounce of the movable element 202 with respect to the fixed element 207 and the bounce of the valve body 214 with respect to the valve seat 218.

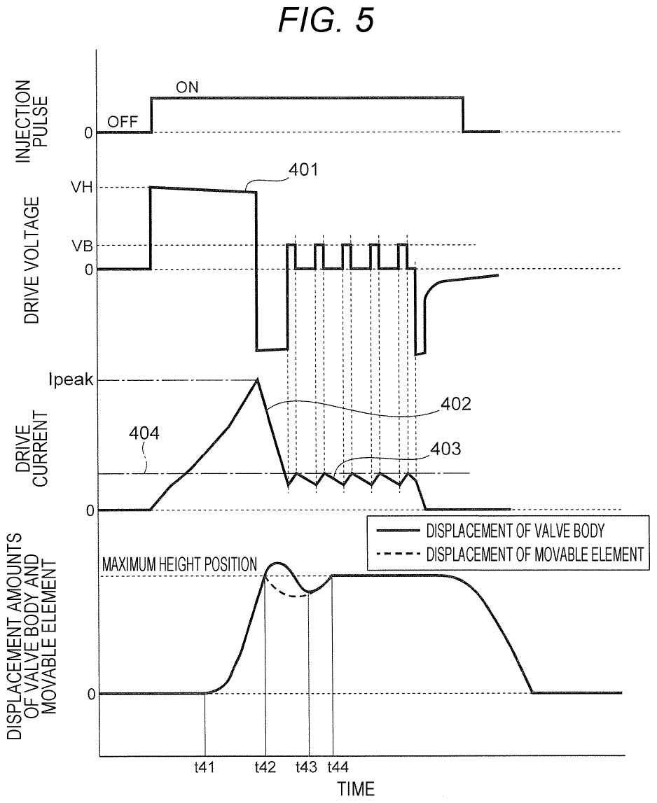

FIG. 5 is a diagram illustrating a relationship among the injection pulse output from the ECU 104, a drive voltage applied to the solenoid 205 of the fuel injection device 101, the drive current supplied to the solenoid 205, and displacement amounts of the valve body 214 and the movable element 202.

When the injection pulse is input to the drive circuit 103, the drive circuit 103 applies a high voltage 401 from a voltage source VH, which is boosted to a voltage higher than a battery voltage VB, to the solenoid 205, and starts supplying the drive current to the solenoid 205. When a current value of the drive current reaches a peak current value Ipeak set in advance by the ECU 104, the drive circuit 103 stops applying the high voltage 401. Then, the drive current supplied to the solenoid 205 is fed back to the voltage source VH by a counter electromotive force due to an inductance of the solenoid 205, and rapidly decreases from the peak current value Ipeak like a current 402. When the current value of the drive current becomes smaller than a predetermined current value 404, the drive circuit 103 applies the battery voltage VB to the solenoid 205 and performs control to hold a predetermined current 403.

When the pressure of the fuel supplied to the fuel injection device 101 increases, the differential pressure force acting on the valve body 214 increases, and a time required for the valve body 214 to reach a target opening degree increases. As a result, a timing at which the target opening degree is achieved may be delayed relative to a timing at which the peak current value Ipeak is reached. When the drive current is rapidly decreased like the current 402, the magnetic attraction force acting on the movable element 202 also rapidly decreases, as a result of which behavior of the valve body 214 becomes unstable, and in some cases, the valve may be started to be closed even during energization.

During a transition period from the peak current value Ipeak to the current 403, the drive circuit 103 causes the current caused by the counter electromotive force to flow to a ground potential side, so that the current is regenerated in the circuit, the applied voltage of the solenoid 205 becomes approximately 0 V, and the current 402 can be gradually decreased. As a result, the drive circuit 103 can gradually reduce the magnetic attraction force acting on the movable element 202, and can stabilize the behavior of the valve body 214 at a high fuel pressure. Therefore, the drive circuit 103 can suppress variations in the injection amount.

The fuel injection device 101 is driven by such a profile of the drive current. During a period from the application of the high voltage 401 until the peak current value Ipeak is reached, the movable element 202 and the valve body 214 start to be displaced at a timing t41. Thereafter, the movable element 202 and the valve body 214 reach predetermined maximum height positions. The movable element 202 collides with the fixed element 207 and bounces at a timing t42 at which the movable element 202 reaches the maximum height position. Since the valve body 214 is configured to be relatively displaceable with respect to the movable element 202, the valve body 214 is spaced apart from the movable element 202, and the displacement of the valve body 214 overshoots beyond the maximum height position. Thereafter, the movable element 202 is displaced in the valve opening direction by the magnetic attraction force generated by the current 403 and the force applied by the return spring 212 in the valve opening direction, and becomes stationary at the maximum height position at a timing t44. The valve body 214 is seated on the movable element 202 and displaced in the valve opening direction at a timing t43 and becomes stationary at the maximum height position and enters the valve opened state at the timing t44. In the case of the fuel injection device in which the valve body 214 and the movable element 202 are integrally formed, the displacement amount of the valve body 214 does not allow the valve body 214 to move beyond the maximum height position, and the displacement amounts of the movable element 202 and the valve body 214 after reaching the maximum height position (after the timing t42) become equal.

Height positions of the valve body 214 and the movable element 202 indicate positions of the valve body 214 and the movable element 202 in the valve opening direction from reference positions, the reference positions being positions of the valve body 214 and the movable element 202 in the valve closed state in which the valve body 214 is seated on the valve seat 218. That is, the displacement amounts of the valve body 214 and the movable element 202 are the displacement amounts of the valve body 214 and the movable element 202 from the reference positions. The maximum height positions of the valve body 214 and the movable element 202 are determined in advance according to the position of the fixed element 207 with which the movable element 202 collides. The displacement amount of the valve body 214 is also referred to as a lift amount of the valve body 214. In the present embodiment, the displacement amount of the valve body 214 when the valve body 214 reaches the maximum height position is also referred to as a maximum lift amount.

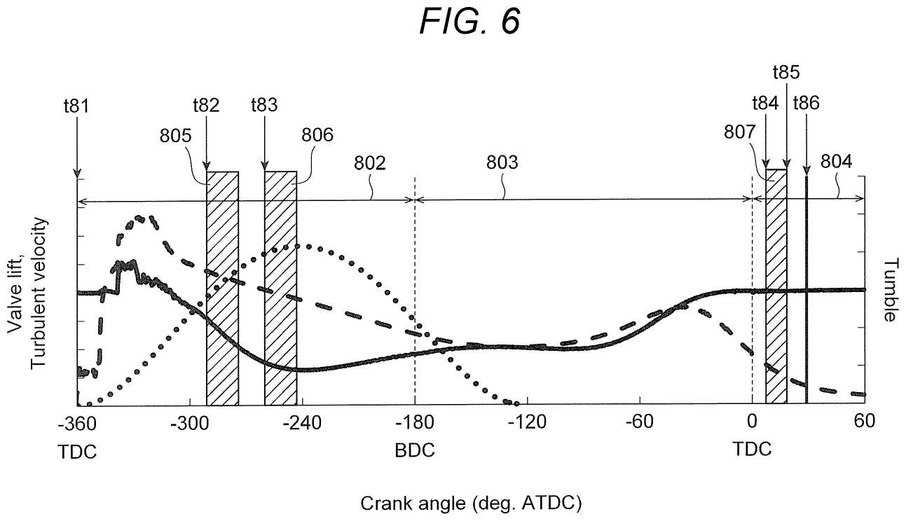

FIG. 6 is a diagram for describing fuel injection control performed during an operation in a catalyst warm-up mode.

A horizontal axis in FIG. 6 represents an angle of the crankshaft 710. In FIG. 6, an angle of the crankshaft 710 at a top dead center (TDC) of the piston 609 in an intake stroke is −360 degrees, an angle of the crankshaft 710 at a bottom dead center (BDC) of the piston 609 is −180 degrees, and an angle of the crankshaft 710 at the TDC of the piston 609 in a compression stroke is 0 degrees. A dotted line in FIG. 6 represents a lift amount of the intake valve 605. A broken line in FIG. 6 represents an average value of a turbulent velocity in the in-cylinder space 615. A solid line in FIG. 6 represents a tumble in the in-cylinder space 615. A hatched portion in FIG. 6 represents a period during which the fuel injection is performed.

During the operation in the catalyst warm-up mode, the control device 150 controls the fuel injection device 101 to perform a plurality of fuel injections during one combustion cycle. At this time, the control device 150 may control the fuel injection device 101 to perform two or more fuel injections in an intake stroke 802 and to perform one or more fuel injections in an expansion stroke 804. In the example of FIG. 6, the control device 150 controls the fuel injection device 101 to perform two fuel injections in the intake stroke 802 and to perform one fuel injection in the expansion stroke 804. In the example of FIG. 6, the control device 150 performs ignition retardation in which an ignition timing is retarded to a timing t86 in the expansion stroke 804. The ignition timing t86 changes according to a timing at which a catalyst temperature increase request is made and environmental conditions, and is set in advance. The control device 150 needs to control the fuel injection device 101 such that appropriate fuel injection is performed at a desired ignition timing t86.

Specifically, at a timing t81 when the piston 609 reaches the TDC and immediately before or at the same time as the exhaust valve 610 is closed, the control device 150 starts to open the intake valve 605 to allow the air to flow into the in-cylinder space 615. At a timing t82 after the opening of the intake valve 605 starts before the maximum lift amount is reached, the control device 150 starts first fuel injection 805. Thereafter, at a timing t83 before the piston 609 reaches the BDC, the control device 150 starts second fuel injection 806. After the piston 609 reaches the BDC and enters a compression stroke 803, and further reaches the TDC, the control device 150 starts third fuel injection 807 at a timing t84 immediately before the ignition timing t86. In the third fuel injection 807, the control device 150 controls the start timing t84 and an end timing t85 of the fuel injection such that a spray injected from the fuel injection device 101 forms a rich air-fuel mixture in which a concentration of the fuel is higher than a stoichiometric air-fuel ratio around the spark plug 604. The control device 150 sets a fuel division ratio between the intake stroke 802 and the expansion stroke 804 such that the intake stroke 802 receives a greater proportion of the fuel. For example, the control device 150 may set the fuel division ratio between the intake stroke 802 and the expansion stroke 804 (intake stroke 802: expansion stroke 804) to approximately 6:4, 7:3, 8:2, or 9:1.

At the timing t86 at which the rich air-fuel mixture is formed between and around the negative electrode 612 and the positive electrode 613 of the spark plug 604, the control device 150 performs ignition to ignite the air-fuel mixture. In order to maintain the air-fuel mixture around the spark plug 604 at the ignition timing t86, the end timing t85 of the fuel injection immediately before the ignition timing t86 may be brought close to the ignition timing t86. That is, the control device 150 controls the fuel injection device 101 such that a period from the end timing t85 of the fuel injection immediately before the ignition timing t86 to the ignition timing t86 becomes shorter as the ignition timing t86 is retarded.

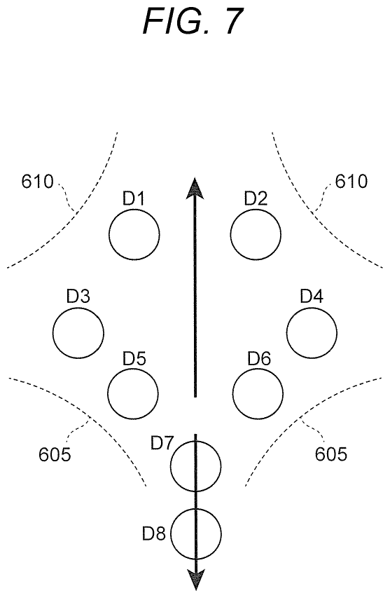

FIG. 7 is a projection view of the spray injected from the fuel injection device 101. FIG. 7 illustrates a projection view of the spray when a cross section of the spray taken along line A-A′ illustrated in FIG. 1 is viewed in a direction toward the fuel injection device 101.

The fuel injection device 101 is a multi-hole type fuel injection device in which the fuel injection hole 219 is formed by a plurality of holes. The spray injected from the fuel injection device 101 includes, for example, eight sprays including sprays D1 and D2 injected toward the spark plug 604, sprays D3 and D4 injected toward the piston 609, and sprays D5 to D8 injected more toward the intake valve 605 than the sprays D3 and D4.

The concept of the present embodiment is to form the air-fuel mixture by the sprays D1 and D2 between and around the negative electrode 612 and the positive electrode 613 of the spark plug 604 in the fuel injection immediately before the ignition timing. The fuel injection device 101 injects the sprays D1 and D2 such that the sprays D1 and D2 are disposed to sandwich the negative electrode 612 and the positive electrode 613. As a result, the fuel injection device 101 can form the air-fuel mixture in which the concentration of the fuel is higher than the stoichiometric air-fuel ratio between and around the negative electrode 612 and the positive electrode 613 and can thus ensure combustion stability.

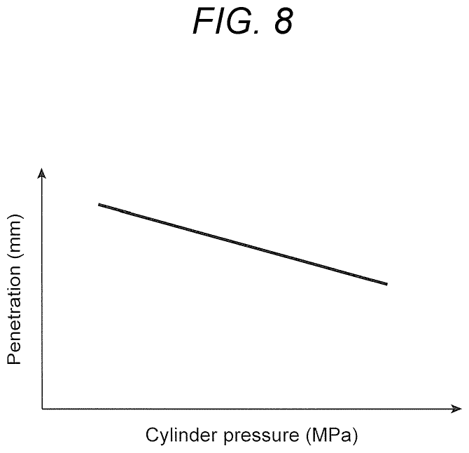

FIG. 8 is a diagram illustrating a relationship between penetration of the spray injected from the fuel injection device 101 and a pressure in the in-cylinder space 615.

The penetration of the spray injected from the fuel injection device 101 is likely to change depending on a change in pressure in the in-cylinder space 615. As illustrated in FIG. 8, the penetration of the spray increases as the pressure in the in-cylinder space 615 decreases. When the penetration of the spray increases, the spray is easily diffused into the in-cylinder space 615, and it becomes difficult to maintain the air-fuel mixture around the spark plug 604 at the ignition timing.

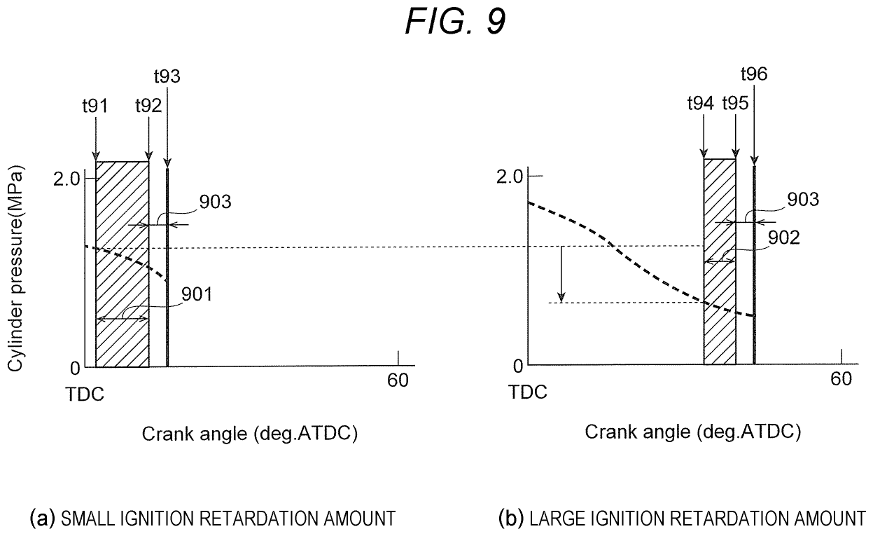

FIG. 9 is a diagram for describing the first embodiment in the fuel injection control performed immediately before the ignition timing, the fuel injection control being performed during the operation in the catalyst warm-up mode. FIG. 9(a) illustrates a case where an ignition retardation amount is small, and FIG. 9(b) illustrates a case where the ignition retardation amount is large. A broken line in FIG. 9 represents the pressure in the in-cylinder space 615. In FIG. 9(a) and 9(b), a load of the internal combustion engine 10 during the operation in the catalyst warm-up mode is the same.

The ignition retardation amount is an amount by which the ignition timing is retarded from the optimum ignition timing for the best fuel efficiency. As the ignition retardation amount increases, the ignition timing is further retarded.

As illustrated in FIG. 9(a), in a case where the ignition retardation amount is small, a start timing t91 of the fuel injection is close to the TDC, and thus, the pressure in the in-cylinder space 615 is high. In this case, the penetration of the spray hardly increases, and thus the air-fuel mixture is hardly diffused into the in-cylinder space 615. In this case, the control device 150 increases a penetration force of the spray by increasing a fuel injection period 901, that is, by increasing the injection amount, thereby facilitating the diffusion of the spray into the in-cylinder space 615. As a result, the control device 150 can easily maintain the air-fuel mixture around the spark plug 604 at an ignition timing t93.

As illustrated in FIG. 9(b), in a case where the ignition retardation amount is large, the pressure in the in-cylinder space 615 at a start timing t94 of the fuel injection is lower than that in the case of FIG. 9(a). In this case, since the penetration of the spray tends to increase, the air-fuel mixture is easily diffused into the in-cylinder space 615. In this case, the control device 150 decreases the penetration force of the spray by shortening a fuel injection period 902, that is, by decreasing the injection amount, thereby suppressing the diffusion of the spray. As a result, the control device 150 can easily maintain the air-fuel mixture around the spark plug 604 at an ignition timing t96. As a result, the control device 150 can stably ignite the air-fuel mixture, so that the combustion stability can be ensured.

Furthermore, in the case illustrated in FIG. 9(b), since the penetration of the spray tends to increase, the fuel tends to adhere to the piston 609 and a wall surface in the in-cylinder space 615, and a particulate number (PN) tends to increase. However, since the control device 150 decreases the injection amount, the fuel adhesion to the piston 609 and the like can be suppressed, and the PN can be reduced.

As described above, the control device 150 controls the fuel injection device 101 such that the injection amount of the fuel injection immediately before the ignition timing decreases as the ignition timing is retarded. As a result, the control device 150 can maintain the air-fuel mixture around the spark plug 604 at the ignition timing, and can suppress the fuel adhesion to the piston 609 and the like. Therefore, the control device 150 can achieve both ensuring of the combustion stability and the reduction of the PN.

In addition, as illustrated in FIGS. 9(a) and 9(b), in a case where the injection amount of the fuel injection immediately before the ignition timing, which is performed in the expansion stroke, changes according to the ignition retardation amount, the control device 150 may perform control to maintain the air-fuel ratio at the stoichiometric air-fuel ratio or constant by adjusting the injection amount of the fuel injection in the intake stroke. Specifically, since the ignition retardation amount is large, in a case where the injection amount of the fuel injection immediately before the ignition timing, which is performed in the expansion stroke, is decreased, the control device 150 controls the fuel injection device 101 such that the injection amount of the fuel injection performed in the intake stroke increases according to the decrease in injection amount. As a result, the control device 150 can reliably ensure the combustion stability by maintaining the air-fuel ratio at the stoichiometric air-fuel ratio or constant while reducing the PN.

Further, in a case where two or more fuel injections are performed in the intake stroke, the control device 150 may control the fuel injection device 101 such that the injection amount of the fuel injection performed as the second or subsequent fuel injection in the intake stroke increases. For example, the control device 150 may increase the fuel injection period or increase the injection pulse width such that the injection amount of the fuel injection (for example, the fuel injection 806 in FIG. 6) performed as the second or subsequent fuel injection in the intake stroke increases by a decreased amount of the injection amount immediately before the ignition timing, which is performed in the expansion stroke.

The air-fuel mixture is less likely to be diffused in the second fuel injection (for example, the fuel injection 806 of FIG. 6) in the intake stroke than in the first fuel injection (for example, the fuel injection 805 of FIG. 6) in the intake stroke. Therefore, by increasing the injection amount of the second fuel injection in the intake stroke, an effect of forming the rich air-fuel mixture in the in-cylinder space 615 over a wide range and ensuring the combustion stability can be further enhanced. In addition, since the injection timing is later in the second fuel injection in the intake stroke than in the first fuel injection in the intake stroke, a time for mixing the air and the fuel increases, and the air and the fuel are less likely to be mixed. Therefore, when the injection amount of the second fuel injection in the intake stroke is increased, the rich air-fuel mixture can be more easily formed over a wide range around the spark plug 604, and the effect of ensuring the combustion stability can be further enhanced.

### Second Embodiment

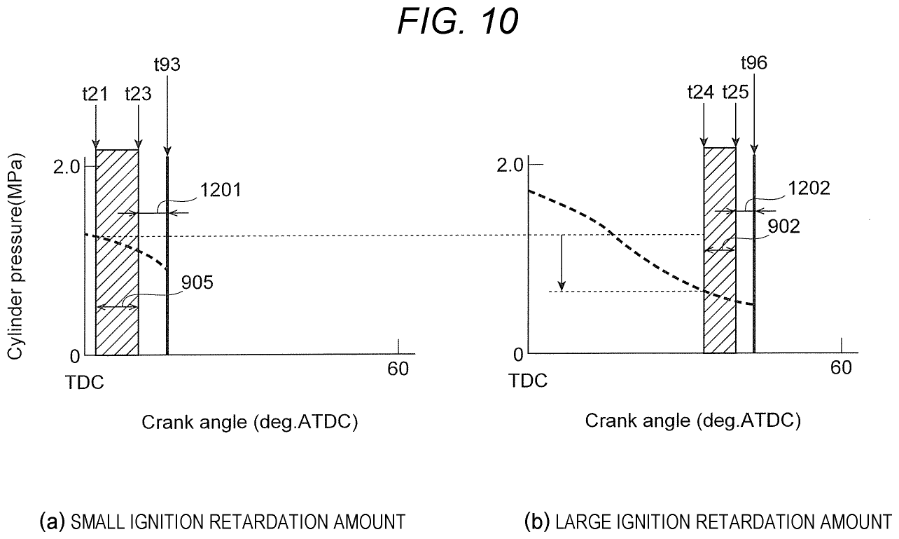

A control device 150 for a fuel injection device 101 according to a second embodiment will be described with reference to FIGS. 10 to 12. In the control device 150 for the fuel injection device 101 according to the second embodiment, a description of the same configuration and operation as those of the first embodiment will be omitted.

FIG. 10 is a diagram for describing the second embodiment in the fuel injection control immediately before an ignition timing, the fuel injection control being performed during an operation in a catalyst warm-up mode. FIG. 10(a) illustrates a case where an ignition retardation amount is small, and FIG. 10(b) illustrates a case where the ignition retardation amount is large. A broken line in FIG. 10 represents a pressure in an in-cylinder space 615. In FIGS. 10(a) and 10(b), a load of an internal combustion engine 10 during the operation in the catalyst warm-up mode is the same.

The control device 150 according to the second embodiment performs the following fuel injection control in addition to the fuel injection control according to the first embodiment in which the fuel injection device 101 is controlled such that an injection amount of the fuel injection immediately before the ignition timing decreases as the ignition retardation amount increases. That is, the control device 150 according to the second embodiment controls the fuel injection device 101 such that a period from an end timing of the fuel injection immediately before the ignition timing to the ignition timing becomes shorter as the ignition retardation amount increases, that is, as the ignition timing is retarded. Specifically, the control device 150 performs control such that a period 1202 when the ignition retardation amount is large is shorter than a period 1201 from an end timing t23 of the fuel injection to an ignition timing t93 when the ignition retardation amount is small.

When the ignition retardation amount is large, the pressure in the in-cylinder space 615 at a start timing t24 of the fuel injection becomes lower than that when the ignition retardation amount is small, so that penetration of spray increases and an air-fuel mixture is easily diffused into the in-cylinder space 615. As a result, it is difficult to maintain a rich air-fuel mixture around a spark plug 604 at an ignition timing t96.

The control device 150 according to the second embodiment can form a stably rich air-fuel mixture around the spark plug 604 and ensure combustion stability by shortening the period 1202 from an end timing t25 of the fuel injection to the ignition timing t96 as the ignition retardation amount increases. However, in a case where the period 1202 is excessively short, the end timing t25 of the fuel injection approaches the ignition timing t96, as a result of which a time during which the spray can be vaporized is shortened, and the air-fuel mixture may be ignited before the spray is completely vaporized. However, since the control device 150 according to the second embodiment can shorten a time required for vaporization of the spray by decreasing the injection amount, fuel adhesion to a piston 609 and the like can be suppressed at the ignition timing t96, and a PN can be reduced while ensuring the combustion stability. Furthermore, for example, by reducing an extremely rich air-fuel mixture having an equivalence ratio of 2 or more, the PN can be further reduced.

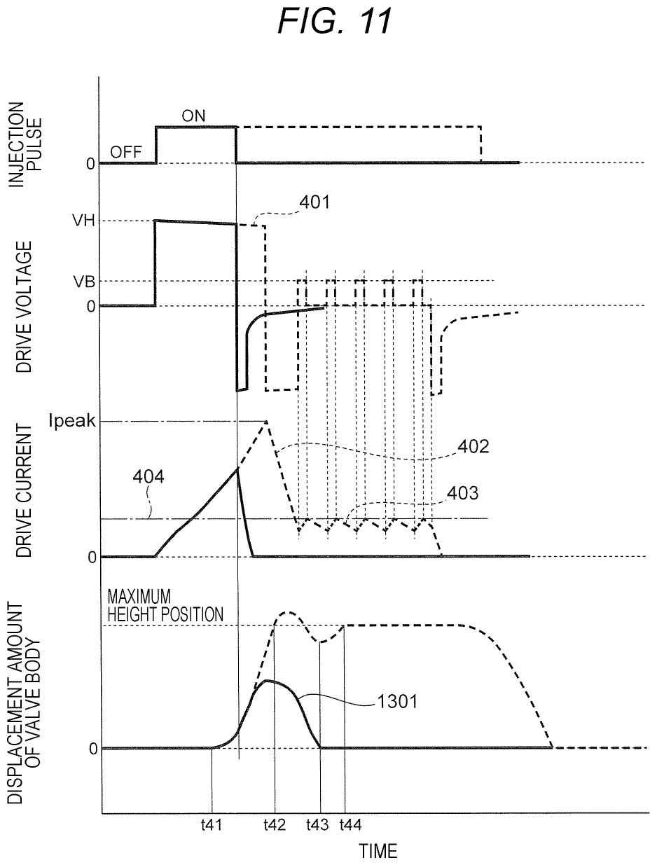

FIG. 11 is a diagram illustrating a relationship among an injection pulse output from an ECU 104, a drive voltage applied to a solenoid 205 of the fuel injection device 101, a drive current supplied to the solenoid 205, and a displacement amount of a valve body 214 in the second embodiment. FIG. 11 is a diagram corresponding to FIG. 5. A broken line in FIG. 11 represents each waveform according to the first embodiment illustrated in FIG. 5, and a solid line in FIG. 11 represents each waveform according to the second embodiment.

The control device 150 according to the second embodiment controls the valve body 214 such that the valve body 214 operates according to a transition 1301 of the displacement amount as illustrated in FIG. 11 in the fuel injection immediately before the ignition timing. That is, the control device 150 controls the valve body 214 such that the valve body 214 is displaced in a height position range lower than a maximum height position in the fuel injection immediately before the ignition timing. In other words, the control device 150 according to the second embodiment controls a lift amount of the valve body 214 in the fuel injection immediately before the ignition timing within a range smaller than a predetermined maximum lift amount.

Then, the control device 150 controls the fuel injection device 101 such that the lift amount of the valve body 214 decreases as the ignition retardation amount increases, that is, as the ignition timing is retarded. As the lift amount of the valve body 214 decreases, a pressure loss o a fuel flowing between the valve body 214 and a valve seat 218 increases, and a flow velocity of the spray decreases. Therefore, even when the ignition timing is retarded and the pressure in the in-cylinder space 615 decreases at the fuel injection timing, the air-fuel mixture can be easily formed in the vicinity of the spark plug 604, and the combustion stability can be ensured.

The control device 150 decreases the lift amount of the valve body 214 as the ignition retardation amount increases. However, the control device 150 may also perform control such that the valve body 214 reaches the maximum height position when the ignition retardation amount is small. As a result, an upper limit value of the lift amount of the valve body 214 can be greatly changed according to the ignition retardation amount, and the air-fuel mixture can be easily maintained around the spark plug 604 when the pressure in the in-cylinder space 615 that changes according to the ignition retardation amount changes.

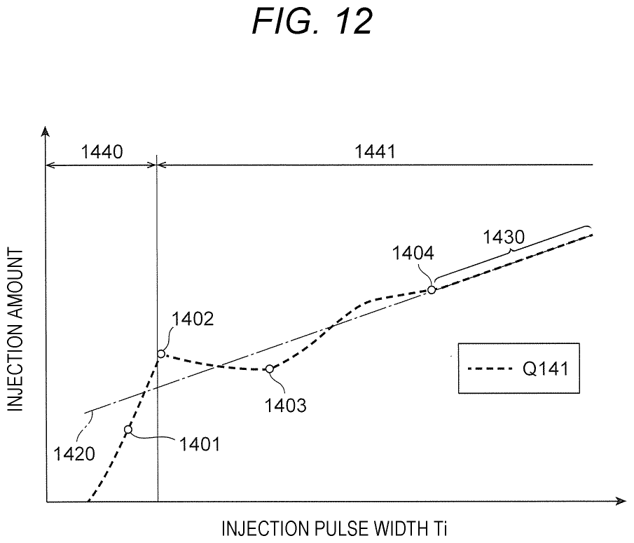

FIG. 12 is a diagram illustrating a relationship between an injection pulse width Ti and the injection amount of the fuel injection device 101. FIG. 12 illustrates an injection amount characteristic Q141 in the case of using each waveform illustrated in FIG. 11.

When the injection pulse width Ti does not reach a predetermined time, the valve body 214 does not start to be opened and the fuel is not injected in a case where a force in a valve opening direction, which is a resultant force of a magnetic attraction force acting on a movable element 202 and a return spring 212, does not exceed a force applied by a spring 210. Alternatively, even when the movable element 202 starts to be displaced, the magnetic attraction force necessary for sliding in a gap 301 cannot be secured, and when the movable element 202 does not come into contact with the valve body 214, the valve body 214 does not start to be opened, and the fuel is not injected. In addition, in a case where the injection pulse width Ti is small, for example, as at a point 1401 in FIG. 12, the movable element 202 collides with the valve body 214, and the valve body 214 is separated from the valve seat 218 and starts to be displaced. However, since valve closing starts before the valve body 214 reaches the maximum height position, the injection amount decreases to be lower than an alternating long and short dash line 1420 extrapolated from a linear region 1430 in which a relationship between the injection pulse width Ti and the injection amount is substantially straight.

In the case of the injection pulse width Ti at a point 1402, the valve closing starts immediately after the valve body 214 reaches the maximum height position, and a trajectory of the valve body 214 becomes a parabolic motion. In this case, since kinetic energy of the valve body 214 in the valve opening direction is large and the magnetic attraction force acting on the movable element 202 is large, a ratio of a time required for the valve closing increases, and the injection amount increases to be higher than the alternating long and short dash line 1420.

In the present embodiment, in the injection amount characteristic Q141, a region 1440 in which the movable element 202 does not collide with a fixed element 207, that is, the valve body 214 does not reach the maximum height position and the trajectory of the valve body 214 becomes a parabolic motion, is also referred to as a “half lift region 1440”. In the present embodiment, in the injection amount characteristic Q141, a region 1441 in which the movable element 202 collides with the fixed element 207, that is, the valve body 214 reaches the maximum height position, is also referred to as a “full lift region 1441”. A solid line in FIG. 11 represents a case where the valve body 214 is displaced in the half lift region 1440.

In the case of the injection pulse width Ti at a point 1403, the valve closing starts at a timing at which an amount of bounce of the valve body 214 caused by the collision of the movable element 202 with the fixed element 207 is maximized. As a result, a repulsive force when the movable element 202 and the fixed element 207 collide with each other acts on the movable element 202, and a valve closing delay time from when the injection pulse is turned off to when the valve body 214 is closed is reduced. As a result, the injection amount decreases to be lower than the alternating long and short dash line 1420.

In the case of the injection pulse width Ti at a point 1404, the valve closing starts at a timing immediately after the bounce of the valve body 214 converges. In the case of the injection pulse width Ti larger than that at the point 1404, the injection amount increases substantially linearly as the injection pulse width Ti increases. In a region from the start of the fuel injection to the injection pulse width Ti at the point 1404, the valve body 214 does not reach the maximum height position, or even if the valve body 214 reaches the maximum height position, the bounce of the valve body 214 is not stabilized, and thus, the injection amount fluctuates. The fuel injection immediately before the ignition timing, which is performed in an expansion stroke, has a large influence on the combustion stability when the injection amount fluctuates. Therefore, the control device 150 may adjust the injection pulse width Ti such that the valve body 214 is displaced in the half lift region 1440 or the linear region 1430. As a result, the control device 150 more easily ensures the combustion stability.

### Third Embodiment

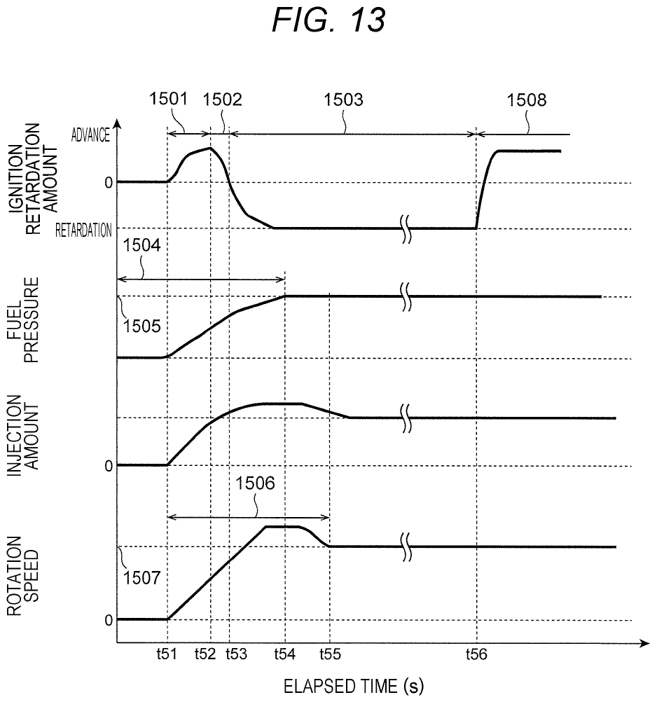

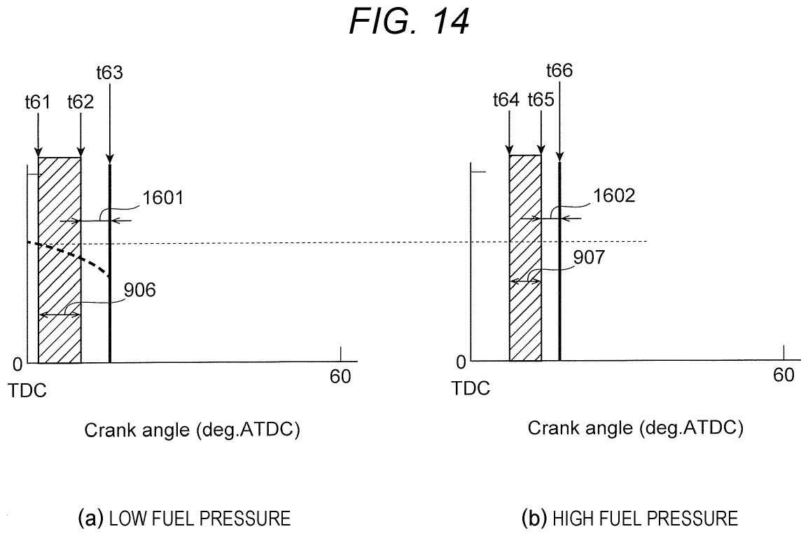

A control device 150 for a fuel injection device 101 according to a third embodiment will be described with reference to FIGS. 13 and 14. In the control device 150 for the fuel injection device 101 according to the third embodiment, a description of the same configuration and operation as those of the first and second embodiments will be omitted.

FIG. 13 is a diagram illustrating a relationship among an ignition retardation amount, a fuel pressure, an injection amount, a rotation speed of an internal combustion engine 10, and an elapsed time from the start of the internal combustion engine 10. In FIG. 13, a case where the ignition retardation amount is 0 indicates a case where an ignition timing is set to a timing of a TDC of a compression stroke. In FIG. 13, a case where the ignition retardation amount corresponds to retardation indicates a case where the ignition timing is set on a retardation side with respect to the TDC of the compression stroke. In FIG. 13, a case where the ignition retardation amount corresponds to advance indicates a case where the ignition timing is set on an advance side with respect to the TDC of the compression stroke.

In a cranking period 1501 from a start timing t51 of the internal combustion engine 10 to a timing at which combustion is stabilized, the control device 150 sets the ignition retardation amount on the advance side (the ignition timing is on the advance side with respect to the TDC of the compression stroke), thereby implementing stable combustion and increasing a temperature in an in-cylinder space 615. After a timing t52 at which cranking ends, the control device 150 increases an exhaust loss by shifting the ignition retardation amount to the retardation side (the ignition timing is on the retardation side with respect to the TDC of the compression stroke), and increases a temperature of exhaust gas discharged from the in-cylinder space 615 to an exhaust port 608. As a result, the control device 150 can activate a catalyst of a catalyst device 703 at an early stage, and can reduce HC.

In addition, in the cranking period 1501, a transition period 1502 until the ignition retardation amount is shifted to the retardation side, and an operation period 1503 in a catalyst warm-up mode, which is a period after the ignition retardation amount is shifted to the retardation side, there is a transition period 1504 in which a pressure of a fuel (hereinafter, also referred to as “fuel pressure”) supplied to the fuel injection device 101 changes (increases). A fuel pump that supplies a high-pressure fuel to the fuel injection device 101 supplies the high-pressure fuel to a fuel pipe communicating with the fuel injection device 101 by a compression operation of a plunger synchronized with a camshaft of the internal combustion engine 10. Therefore, when the rotation speed of the internal combustion engine 10 is low, a certain time is required for the fuel pressure to reach a target pressure 1505. That is, the transition period 1504 in which the fuel pressure changes occur between the start timing t51 of the internal combustion engine 10 and a timing t56 at which the warming up of the catalyst ends. In particular, in a hybrid vehicle (hybrid electric vehicle (HEV), series hybrid electric vehicle (SHEV), or plug-in hybrid electric vehicle (PHEV) ) on which the internal combustion engine 10 and an electric motor are mounted, since a frequency of starting and stopping the internal combustion engine 10 increases as compared with a vehicle on which only the internal combustion engine 10 is mounted, the fuel pressure at the time of starting the internal combustion engine 10 changes frequently.

FIG. 14 is a diagram for describing the third embodiment in fuel injection control performed immediately before the ignition timing during an operation in the catalyst warm-up mode. FIG. 14(a) illustrates a case where the fuel pressure is low, and FIG. 14(b) illustrates a case where the fuel pressure is high. In FIGS. 14(a) and 14(b), it is assumed that the ignition retardation amount is the same.

In a case where the fuel pressure is low, a penetration force of a spray decreases, and thus, the spray is less likely to diffuse in the in-cylinder space 615. In a case where the fuel pressure is high, the penetration force of the spray increases, and thus, the spray is easily diffused in the in-cylinder space 615. Therefore, in a case where the fuel pressure changes, it is desirable to adjust at least one of an end timing of the fuel injection immediately before the ignition timing and the injection amount.

The control device 150 according to the third embodiment controls the fuel injection device 101 such that a period from the end timing of the fuel injection immediately before the ignition timing to the ignition timing increases as the pressure of the fuel supplied to the fuel injection device 101 at a start timing of the fuel injection immediately before the ignition timing decreases. Furthermore, the control device 150 controls the fuel injection device 101 such that the injection amount of the fuel injection immediately before the ignition timing increases as the fuel pressure decreases.

Specifically, the control device 150 performs control such that a period 1601 when the fuel pressure is low is longer than a period 1602 from an end timing t65 of the fuel injection to an ignition timing t66 when the fuel pressure is high. As a result, the control device 150 can easily diffuse the spray in the in-cylinder space 615, so that an air-fuel mixture can easily reach the periphery of the spark plug 604, and combustion stability can be ensured. Furthermore, the control device 150 performs control such that a fuel injection period 906 when the fuel pressure is low is longer than a fuel injection period 907 when the fuel pressure is high. As a result, the control device 150 can easily diffuse the spray by increasing the penetration force of the spray, so that the air-fuel mixture can easily reach the periphery of the spark plug 604, and the combustion stability can be further ensured.

On the other hand, the control device 150 according to the third embodiment controls the fuel injection device 101 such that the injection amount of the fuel injection immediately before the ignition timing decreases as the pressure of the fuel supplied to the fuel injection device 101 at the start timing of the fuel injection immediately before the ignition timing increases. Furthermore, the control device 150 controls the fuel injection device 101 such that the period from the end timing of the fuel injection immediately before the ignition timing to the ignition timing decreases as the fuel pressure increases.

Specifically, the control device 150 performs control such that the fuel injection period 907 when the fuel pressure is high is shorter than the fuel injection period 906 when the fuel pressure is low. As a result, since the control device 150 can decrease the penetration force of the spray and suppress the diffusion of the spray, fuel adhesion to a piston 609 and the like can be suppressed, and a PN can be reduced while ensuring the combustion stability. Furthermore, the control device 150 performs control such that the period 1602 when the fuel pressure is high is shorter than the period 1601 from an end timing t62 of the fuel injection to an ignition timing t63 when the fuel pressure is low. As a result, the control device 150 can make it difficult for the spray to be diffused in the in-cylinder space 615, can easily maintain the air-fuel mixture around the spark plug 604, and can suppress the fuel adhesion to the piston 609 and the like, so that it is possible to highly achieve both ensuring of the combustion stability and reduction of the PN.

As described above, since the control device 150 can adjust at least one of the end timing of the fuel injection immediately before the ignition timing and the injection amount according to a change in fuel pressure, the air-fuel mixture can be formed around the spark plug 604 even when the fuel pressure changes, and the combustion stability can be ensured. Although it is effective to adjust the end timing of the fuel injection immediately before the ignition timing and the injection amount independently, it is possible to greatly control a diffusion state of the spray in the in-cylinder space 615 by adjusting both of the end timing and the injection amount, and thus, it is possible to further enhance the effects of ensuring the combustion stability and reducing the PN.

In the hybrid vehicle (HEV, SHEV, or PHEV) on which the internal combustion engine 10 and the electric motor are mounted, the fuel pressure at the time of starting the internal combustion engine 10 frequently changes as described above. Therefore, it is particularly effective that the control device 150 according to the third embodiment is applied to the hybrid vehicle, and the effects of ensuring the combustion stability and reducing the PN in the hybrid vehicle can be further enhanced.

Note that the present invention is not limited to the above embodiments and includes various modified examples. For example, the above-described embodiments have been described in detail in order to describe the present invention in an easy-to-understand manner, and the present invention is not necessarily limited to those having all the described configurations. Further, a part of the configuration of one embodiment can be replaced with the configuration of another embodiment, and the configuration of one embodiment can be added to the configuration of another embodiment. In addition, it is possible to add, delete, and replace other configurations for a part of the configuration of each embodiment.

In addition, some or all of the above-described configurations, functions, processing units, processing means, or the like may be implemented by hardware, for example, by designing with an integrated circuit or the like. In addition, each of the above-described configurations, functions, and the like may be implemented by software by a processor interpreting and executing a program for implementing each function. Information: such as a program, a table, or a file for implementing each function can be stored in a recording device such as a memory, a hard disk, or a solid state drive (SSD), or a recording medium such as an integrated circuit (IC) card, a secure digital (SD) card, or a digital versatile disk (DVD).

In addition, the control lines and the information lines indicate those considered to be necessary for the description, and do not necessarily indicate all the control lines and the information lines for the product. In practice, it may be considered that almost all the configurations are connected to each other.

### REFERENCE SIGNS LIST

10 internal combustion engine
101 fuel injection device
150 control device
214 valve body
219 fuel injection hole
615 in-cylinder space

1. A control device for a fuel injection device that directly injects a fuel into an in-cylinder space of an internal combustion engine operating in a catalyst warm-up mode in which a catalyst is warmed up by ignition retardation in which an ignition timing is retarded to an expansion stroke, the control device controlling the fuel injection device such that fuel injection immediately before the ignition timing among a plurality of fuel injections performed during one combustion cycle is performed in the expansion stroke during the operation in the catalyst warm-up mode, and an injection amount of the fuel injection immediately before the ignition timing decreases as the ignition timing is retarded.

2. The control device for the fuel injection device according to claim 1, wherein the control device controls the fuel injection device such that a period from an end timing of the fuel injection immediately before the ignition timing to the ignition timing decreases as the ignition timing is retarded.

3. The control device for the fuel injection device according to claim 1, wherein the control device controls the fuel injection device such that two or more fuel injections are performed in an intake stroke, and an injection amount of a second or subsequent fuel injection in the intake stroke increases according to a decrease in fuel injection immediately before the ignition timing.

4. The control device for the fuel injection device according to claim 1, wherein
the fuel injection device includes a valve body that closes or opens a fuel injection hole through which the fuel is injected, and
the control device controls a lift amount of the valve body in the fuel injection immediately before the ignition timing in a range smaller than a predetermined maximum lift amount, and controls the valve body such that the lift amount decreases as the ignition timing is retarded.

5. A control device for a fuel injection device that directly injects a fuel into an in-cylinder space of an internal combustion engine operating in a catalyst warm-up mode in which a catalyst is warmed up by ignition retardation in which an ignition timing is retarded to an expansion stroke, the control device controlling the fuel injection device such that fuel injection immediately before the ignition timing among plurality of fuel injections performed during one combustion cycle is performed in the expansion stroke during the operation in the catalyst warm-up mode, and a period from an end timing of the fuel injection immediately before the ignition timing to the ignition timing decreases as a pressure of the fuel supplied to the fuel injection device at a start timing of the fuel injection immediately before the ignition timing increases.

6. The control device for the fuel injection device according to claim 5, wherein the control device controls the fuel injection device such that an injection amount of the fuel injection immediately before the ignition timing decreases as the pressure of the fuel at the start timing of the fuel injection immediately before the ignition timing increases.
